(19) United States
(12) Patent Application Publication
(10) Pub. No.: US 2026/0326122 A1
(43) Pub. Date: Oct. 22, 2026

(54) Diaphragm for a device for applying a coating product and associated application device

(71) Applicant: EXEL INDUSTRIES, EPERNAY (FR)

(72) Inventors: Paulo DOS SANTOS, Aulnay-sous-Bois (FR); Alexandre Emmanuel Alain PINEAU, PARIS (FR); Pierre Shinji DEVINES, INGRE (FR); Pascal Laurent BUATOIS, NOISY LE SEC (FR); Philippe Bernard MULLER, Asnières sur Oise (FR)

(21) Appl. No.: 19/641,974

(22) Filed: Apr. 8, 2026

(30) Foreign Application Priority Data
Apr. 8, 2025 (FR) 2503704

(51) Int. Cl. B05B 1/34

(52) U.S. Cl. CPC B05B 1/3402

(57) ABSTRACT

A diaphragm for an application device of a coating product, the diaphragm including a duct defining a passage for circulation of product, the duct extending along a central axis between an inlet end and an outlet end and having cylindrical symmetry around the central axis. The duct successively includes an upstream portion and a downstream portion. The duct includes a throttling portion arranged between the upstream and downstream portions and having a narrowed section relative to a section of the upstream and downstream portions. The upstream and downstream portions each have a general shape flaring, preferably convexly, from the throttling portion toward the respective end of the duct.

### CROSS-REFERENCE TO RELATED APPLICATION

This application is a U.S. non-provisional application claiming the benefit of French Application No. 25 03704, filed on Apr. 8, 2025, which is incorporated herein by reference in its entirety.

### TECHNICAL FIELD OF THE INVENTION

The present invention relates to a diaphragm for an application device, in particular for a spray gun for coating product, a spray nozzle including such a diaphragm, and an application device including such a diaphragm.

### BACKGROUND OF THE INVENTION

Application devices for coating product, such as spray guns, are known. They are intended to ensure the break-up of a coating product into fine droplets so as to coat a large surface with a small quantity of product. To that end, the coating product is supplied under pressure by a source and conveyed to a spray nozzle.

Several solutions exist for carrying out this spraying.

Firstly, pneumatic spraying may be mentioned. According to this solution, the coating product is supplied by the source with a very low overpressure relative to atmospheric pressure, typically between 0.5 and 1.5 bar. Compressed air is blown at the nozzle outlet, and it is mainly this compressed air that atomizes the liquid film ejected by the nozzle. This solution has the advantage of providing a very high finish quality. It is also relatively inexpensive. However, it has the drawback of a low transfer rate, a large quantity of the coating product being dispersed into the environment without reaching the surface to be coated.

Another solution is airless spraying. According to this solution, the coating product is supplied by the source at very high pressure, typically at a pressure between 160 and 300 bar. Then only the narrowness of the spray orifice causes the product to break up. No air is involved. This solution has the advantage of an excellent transfer rate. However, it has the drawback of requiring pumping equipment capable of supplying the coating product at very high pressure, and involves costly energy consumption.

A final solution is mixed spraying. According to this technology, the coating product is supplied by the source at high pressure, typically at a pressure between 50 and 150 bar. As in the case of airless spraying, the narrowness of the spray orifice causes the product to break up. However, this spraying is not optimal, given the relatively low pressure at which the coating product is supplied by the source. To improve atomization of the product, compressed air is blown at the nozzle outlet, as in pneumatic spraying technology. Compressed air is also blown onto the ends of the jet to fold back the sprayed paint and prevent the formation of concentrated paint portions, called horns, at these product pressures. This solution makes it possible to obtain substantially the same finish quality as with airless spraying, with a good transfer rate, while being more economical since the coating product is supplied at a lower pressure. However, it has the drawback of remaining relatively costly compared with the pneumatic spraying solution.

### SUMMARY OF THE INVENTION

An objective of the invention is to reduce the pressure at which the coating product must be supplied, while maintaining satisfactory transfer rates and finish qualities.

To that end, the invention relates to a diaphragm for an application device of a coating product, the diaphragm including a duct defining a passage for circulation of the product, the duct extending along a central axis between an inlet end and an outlet end and having cylindrical symmetry around the central axis, the duct successively including, between the inlet end and the outlet end, an upstream portion and a downstream portion, the duct including a throttling portion arranged between the upstream and downstream portions and having a narrowed section relative to a section of the upstream and downstream portions, the upstream and downstream portions each having a general shape flaring, preferably convexly, from the throttling portion toward the respective end of the duct.

The shape of the diaphragm according to the invention thus makes it possible to progressively accelerate the product by progressively decreasing the passage section in the upstream portion, so that the product circulates at high speed in the throttling portion of constant section, and finally to progressively reduce the speed of the product by progressively increasing the passage section in the downstream portion.

The product may thus be sprayed with a lower pressure compared with a conventional application device, while maintaining good spraying quality.

This reduction in required pressure results in a reduction in the energy required and the possibility of using pressurization equipment reaching a lower pressure, which therefore provides a double saving for the user in energy and equipment.

In addition, the invention helps reduce the volume of the zone likely to be occupied by the product under pressure after spraying stops. Thus, the diaphragm makes it possible to reduce the volume, also called “dead” volume, between the needle of the application device and the nozzle outlet.

Furthermore, the restriction formed by the diaphragm helps retain the liquid in this “dead” volume, so that the liquid does not flow and does not exit the nozzle once spraying has been stopped.

The rounded shape of the portions makes it possible to limit pressure losses and turbulence, thus making it possible to have a product flow that is as laminar as possible.

There is then less turbulence in the spraying, so that the transfer rate of the sprayed product is improved, and less extraction is therefore required in the spray booth.

The diaphragm according to the invention thus makes it possible to reduce the pressure at which the coating product must be supplied, while maintaining satisfactory transfer rates and finish qualities.

According to other advantageous aspects of the invention, the diaphragm may include one or more of the following features, taken alone or in any technically possible combinations:
the throttling portion has a cylindrical shape of constant section;
at least one of the upstream portion and the downstream portion is tangent to the throttling portion;
the upstream portion and the downstream portion each have a respective radius of curvature, the radii of curvature being constant or variable;
the radius of curvature of the upstream portion is different from the radius of curvature of the downstream portion;
the radius of curvature of the downstream portion is strictly greater than the radius of curvature of the upstream portion;
the upstream portion includes a conical frustum-shaped inlet portion;
the upstream portion and the downstream portion each have a length measured along the central axis such that the length of the upstream portion is between 50% and 100%, preferably between 70% and 90% of the length of the downstream portion;
the diaphragm further includes a base at which the duct opens at its inlet end; and
the base includes at least one notch or a relief characteristic of the shape and/or the length of the duct.

The invention also relates to a spray nozzle for an application device of a coating product, the nozzle including at least one diaphragm of the aforementioned type.

According to other advantageous aspects of the invention, the nozzle may also have one or more of the following features, taken alone or in any technically possible combinations:
the nozzle includes a tubular body oriented along an axial direction and internally defining a through-duct opening onto a spray orifice suitable for spraying the product, the nozzle further including a spraying member defining the spray orifice and including, from upstream to downstream, a cavity of transverse section decreasing toward downstream, followed by a channel fluidically connecting the cavity to the spray orifice, the diaphragm being housed at least partly in the through-duct of the nozzle;
the diaphragm is housed at least partly in the cavity of the spraying member, preferably removably; and
the diaphragm is housed upstream of the spraying member, preferably removably.

The invention also relates to an application device for a coating product, such as a gun, including a spray nozzle, the application device further including at least one diaphragm of the aforementioned type.

According to other advantageous aspects of the invention, the device may also have one or more of the following features, taken alone or in any technically possible combinations:
the nozzle includes a tubular body oriented along an axial direction and internally defining a through-duct opening onto a spray orifice suitable for spraying the product, the nozzle further including a spraying member defining the spray orifice and including, from upstream to downstream, a cavity of transverse section decreasing toward downstream, followed by a channel fluidically connecting the cavity to the spray orifice, the diaphragm being housed at least partly in the through-duct of the nozzle;
the diaphragm is housed at least partly in the cavity of the spraying member, preferably removably;
the diaphragm is housed upstream of the spraying member, preferably removably; and
the device includes a seat holder suitable for receiving the spray nozzle in abutment, the seat holder defining the diaphragm.

### BRIEF DESCRIPTION OF THE DRAWINGS

The invention will appear more clearly upon reading the following description, given solely by way of non-limiting example, and made with reference to the drawings wherein:

FIG. 1 is an exploded perspective view, from the front three-quarter angle, of an application device for a coating product according to a first embodiment of the invention;

FIG. 2 is a longitudinal sectional view of a spray nozzle of the device shown in FIG. 1, including a diaphragm according to a first embodiment of the invention;

FIG. 3 is a cutaway perspective view of the diaphragm shown in FIG. 2;

FIG. 4 is an enlarged view of the diaphragm shown in FIG. 2;

FIG. 5 is a longitudinal sectional view of a spray head of the device shown in FIG. 1, including a diaphragm according to a variant of the first embodiment of the invention;

FIG. 6 is a partial longitudinal sectional view of the application device shown in FIG. 1 according to a second embodiment; and

FIG. 7 is a partial longitudinal sectional view of the application device shown in FIG. 1 according to a variant of the second embodiment.

### DETAILED DESCRIPTION

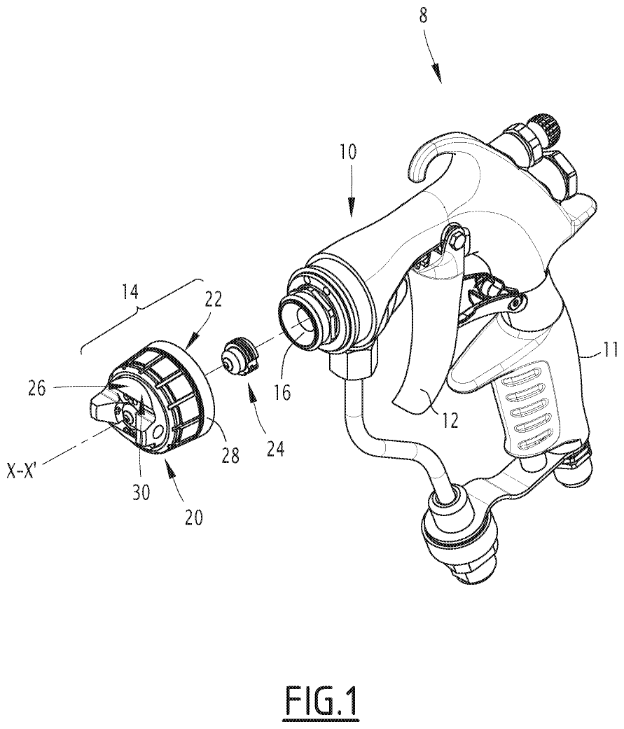

In FIG. 1, an application device 8 for a coating product according to a first embodiment is shown.

Application device 8 is intended to apply the coating product onto a surface to be coated. The coating product is preferably a fluid, for example, a liquid including one or more components or a powder material. It may be paint, a primer, a varnish, etc.

In the following, the orientation terms “upstream” and “downstream” are understood with reference to the direction of circulation of the coating product in device 8, the coating product flowing from upstream to downstream.

In the example shown in FIG. 1, application device 8 is a spray gun, in particular a manual spray gun. As a variant, the spray gun is an automatic spray gun.

Device 8 includes a body 10, a grip handle 11, and an actuation trigger 12 hinged on body 10. Device 8 also includes a spray head 14 mounted on body 10.

Body 10 has an outlet orifice 16 for the coating product.

Spray head 14 is centered on a spray axis X-X′ of device 8.

Spray head 14 includes an annular ring 20 having a central orifice 22 and a spray nozzle 24 housed in central orifice 22.

Annular ring 20 is centered on axis X-X′. Ring 20 includes a body 26 defining central orifice 22, and a skirt 28 mounted rotatably about axis X-X′ relative to body 26.

As visible in FIG. 1, body 26 has a downstream face 30, oriented away from body 10, and an upstream face (not visible) facing body 10.

Spray nozzle 24 is arranged coaxially inside spray head 14.

Spray head 14 and nozzle 24 are configured to be mounted on a seat holder (not shown in FIG. 1), itself mounted on body 10 of device 8.

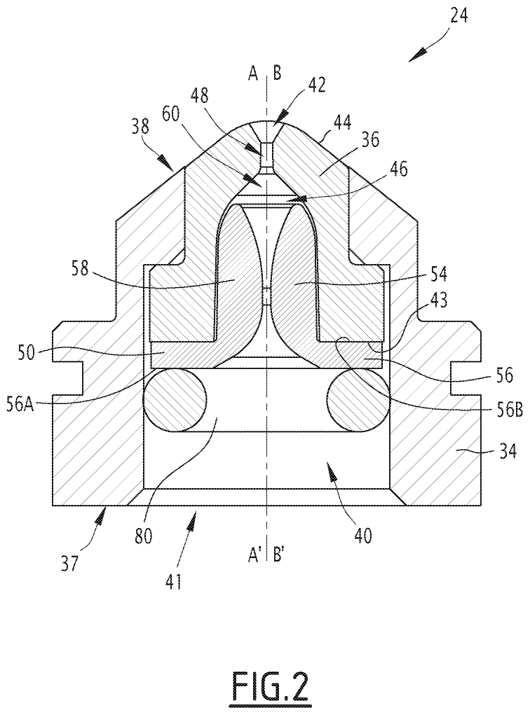

With reference to FIG. 2, nozzle 24 includes a tubular body 34 oriented along an axial direction A-A′, coincident with spray axis X-X′ when nozzle 24 is mounted inside spray head 14. Nozzle 24 further includes a spraying member 36 arranged inside body 34.

Body 34 of nozzle 24 is in particular a cylinder of revolution about axis A-A′.

Body 34 of nozzle 24 has an upstream end 37, oriented toward body 10 of device 8, and a downstream end 38, oriented away from body 10.

Body 34 internally defines a through-duct 40 defining a passage for circulation of the coating product through nozzle 24. Duct 40 opens to the outside of body 34, at upstream end 37, onto a wide connection orifice 41, and at downstream end 38 onto a spray orifice 42 suitable for spraying the product.

Spraying member 36 is inserted partly into duct 40.

Spraying member 36 has an upstream face 43, housed in duct 40, and a downstream face 44, opposite upstream face 43 and arranged outside body 34.

Upstream face 43 is substantially planar and is arranged substantially transversely to axis A-A′.

Downstream face 44 is typically dome-shaped centered on axis A-A′ and is flush at its periphery with downstream end 38 of duct 40.

Spraying member 36 defines spray orifice 42 at its downstream face 44.

Spraying member 36 further includes, from upstream to downstream, a cavity 46 of transverse section decreasing toward downstream, followed by a channel 48 of substantially constant transverse section fluidically connecting cavity 46 to spray orifice 42.

Cavity 46 opens in upstream face 43, upstream face 43 defining, around cavity 46, an annular shoulder 50 oriented upstream.

In the example shown in FIG. 2, cavity 46 has substantially a bell shape.

Channel 48 opens onto an opening forming spray orifice 42.

Application device 8 further includes at least one diaphragm 54.

A diaphragm 54 according to a first embodiment is shown in FIG. 2 4.

Preferably, diaphragm 54 is formed as a single piece.

As visible in FIG. 2, diaphragm 54 according to the first embodiment is housed in through-duct 40 of nozzle 24. In particular, diaphragm 54 is housed partly in cavity 46 of spraying member 36, preferably removably.

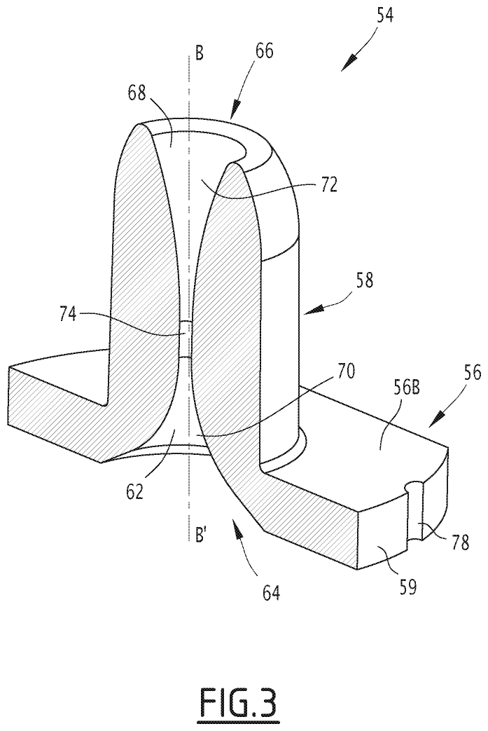

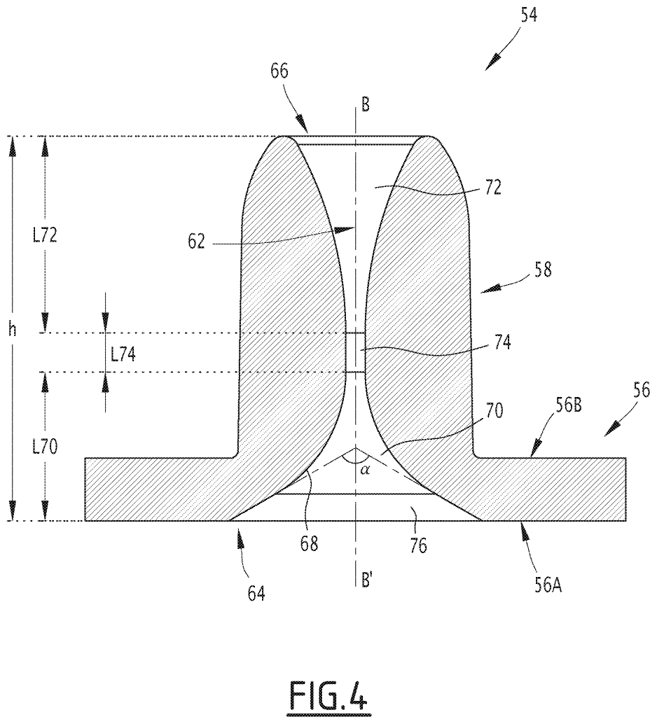

With reference to FIGS. 3 and 4, diaphragm 54 includes a base 56 and an insert body 58 projecting axially from base 56 along a central axis B-B′, coincident with longitudinal axis A-A′ when diaphragm 54 is mounted inside nozzle 24.

Base 56 is housed in through-duct 40 of nozzle 24, outside cavity 46 of spraying member 36. Advantageously, as visible in FIG. 2, base 56 bears against annular shoulder 50 at a downstream face 56B of base 56. Base 56 further defines an upstream face 56A, opposite downstream face 56B.

Preferably, as visible in the sectional view shown in FIG. 3, base 52 has at least one, in particular two, flat(s) 59, to allow gripping of diaphragm 54 and its removal from nozzle 24.

Preferably, as visible in FIG. 2, insert body 58 is received entirely in cavity 46. Insert body 58 preferably has a shape substantially complementary to that of cavity 46, so that, when insert body 58 is received entirely in cavity 46, a free space 60 is defined between insert body 58 and an internal wall of cavity 46, free space 60 having an inner volume smaller than the volume of cavity 46. The product stagnation volume is thus reduced.

Insert body 58 includes a duct 62 defining a passage for circulation of the product. Duct 62 extends along central axis B-B′ between an inlet end 64 and an outlet end 66, forming a free end of insert body 58.

Duct 62 opens at its inlet end 64 at base 52. Duct 62 is bounded by an inner surface 68 of insert body 58.

Preferably, duct 62 has a height h, measured along central axis B-B′ between inlet end 64 and outlet end 66, between 3 mm and 12 mm, more preferably between 3.5 mm and 6 mm.

Insert body 58 advantageously has cylindrical symmetry around central axis B-B′.

A transverse section of duct 62 is defined as a section of duct 62 in a transverse plane normal to central axis B-B′.

In the embodiment illustrated in FIGS. 2-4, duct 62 has substantially round transverse sections.

As shown in FIGS. 3 and 4, duct 62 successively includes, between inlet end 64 and outlet end 66, an upstream portion 70 and a downstream portion 72. Duct 62 further includes a throttling portion 74 arranged between upstream and downstream portions 70, 72.

From upstream to downstream, duct 62 thus includes upstream portion 70, throttling portion 74, and downstream portion 72.

Throttling portion 74 has a transverse section narrowed relative to the transverse sections of upstream and downstream portions 70, 72.

Duct 62 thus has an internal diameter varying between inlet end 64 and outlet end 66. Thus, the internal diameter progressively decreases from inlet end 64 to throttling portion 74, then increases from throttling portion 74 to outlet end 66.

Upstream portion 70 thus defines a converging tube, inlet end 64 having a diameter greater than the diameter of throttling portion 74. Downstream portion 72 defines a diverging tube, outlet end 66 having a diameter greater than the diameter of throttling portion 74. The converging and diverging tubes are coaxial.

A ratio between the diameter of the transverse section of upstream portion 70 at throttling portion 74 and the diameter of the transverse section of upstream portion 70 at inlet end 64 is preferably between 0.05 and 0.35, preferably between 0.07 and 0.22.

For example, upstream portion 70 has a diameter between 2.0 mm and 6.0 mm, preferably between 2.5 mm and 4.0 mm, at inlet end 64, and a diameter between 0.15 mm and 1.0 mm, preferably between 0.15 mm and 0.7 mm, at throttling portion 74.

A ratio between the diameter of the transverse section of downstream portion 72 at throttling portion 74 and the diameter of the transverse section of downstream portion 72 at outlet end 66 is preferably between 0.1 and 0.40.

For example, downstream portion 72 has a diameter between 0.5 mm and 7.0 mm at outlet end 66, and a diameter between 0.15 mm and 1.0 mm, preferably between 0.15 mm and 0.7 mm, at throttling portion 74.

According to a particular embodiment (not shown), upstream portion 70 and downstream portion 72 are symmetrical with each other with respect to a median plane, duct 62 having substantially the shape of a catenoid.

Preferably, as visible in FIGS. 2-4, upstream portion 70 and downstream portion 72 are not symmetrical with each other.

Upstream portion 70 and downstream portion 72 each have a respective length L70, L72 measured along central axis B-B′. Preferably, length L70 of upstream portion 70 is less than length L72 of downstream portion 72.

Preferably, length L70 of upstream portion 70 represents between 50% and 100%, preferably between 70% and 90%, of length L72 of downstream portion 72.

Typically, upstream portion 70 has a length L70 between 1.4 mm and 6.0 mm and downstream portion 73 has a length L72 between 1.6 mm and 7.0 mm.

As visible in FIGS. 3 and 4, upstream and downstream portions 70, 72 each have a general shape flaring from throttling portion 74 toward respective end 64, 66 of duct 62.

Advantageously, as visible in more detail in FIGS. 3 and 4, upstream and downstream portions 70, 72 each have a general shape flaring convexly from throttling portion 74 to respective end 64, 66 of duct 62.

Upstream portion 70 thus advantageously has a rounded shape flaring from throttling portion 74 toward inlet end 64.

Preferably, as visible in FIG. 4, upstream portion 70 includes an inlet portion 76 of conical frustum shape, opening at upstream face 56A of base 56. Inlet portion 76 makes it possible to avoid too abrupt a reduction in section of duct 62, while having an inlet end 64 of suitable diameter.

Advantageously, inlet portion 76 is tangent with the remainder of upstream portion 70 and inner surface 68 of upstream portion 70 has no edge.

Preferably, inlet portion 76 defines a convergence angle α between 90° and 150°, preferably between 120° and 150°.

Upstream portion 70 thus makes it possible to accelerate the product uniformly, over a short distance, by a uniform reduction of the passage section. This reduction advantageously occurs without jerks, starting from a diameter similar to the diameter of a product supply line.

Downstream portion 72 advantageously has a rounded shape flaring from throttling portion 74 toward outlet end 66.

The rounding of downstream portion 72 makes it possible to benefit from the Coanda effect. The product flow is thus as wide and as unperturbed as possible, which limits cavitation effects or product stagnation. The flared outlet thus makes it possible to limit turbulence, making it possible both to limit pressure losses and the micro-bubbling effect of the projected product.

Upstream portion 70 and downstream portion 72 thus each have a trumpet-bell shape. The rounded shapes of upstream 70 and downstream 72 portions make it possible to limit pressure losses, as well as turbulence, so as to have a laminar flow.

Duct 62 has a double-funnel shape.

Diaphragm 54, with the reduction then enlargement of the section of duct 62 before channel 48 of spraying member 36, makes it possible to benefit from a double restriction effect and thus to reduce the product pressure required for spraying.

In addition, the double-funnel shape facilitates cleaning of duct 62 and thus elimination of any impurity harmful to spraying.

Upstream portion 70 and downstream portion 72 each have a respective radius of curvature. Any possible presence of a conical frustum-shaped inlet portion 76 is not taken into account here.

In the embodiment shown in FIGS. 2-4, the radii of curvature of upstream and downstream portions 70, 72 are constant. Thus, the curvature of inner surface 68 at upstream portion 70 is a simple curve with a constant radius, and the curvature of inner surface 68 at downstream portion 72 is a simple curve with a constant radius.

In a variant not shown, at least one of the radii of curvature is variable. In this case, at least one of upstream portion 70 and downstream portion 72 includes a succession of portions with variable radius of curvature, each of which is tangent with the preceding portion and/or with the following portion.

Advantageously, the radius of curvature of upstream portion 70 is different from the radius of curvature of downstream portion 72.

Preferably, as visible in FIG. 4, the radius of curvature of downstream portion 72 is strictly greater than the radius of curvature of upstream portion 70.

This makes it possible to have a deceleration of product flow that is more progressive than its acceleration.

For example, the radius of curvature of upstream portion 70 is between 0.5 mm and 4.0 mm, preferably between 1.2 mm and 2.0 mm.

For example, the radius of curvature R72 of downstream portion 72 is between 2.0 mm and 6.0 mm.

Preferably, at least one of upstream portion 70 and downstream portion 72 is tangent to throttling portion 74. Even more preferably, upstream portion 70 and downstream portion 72 are both tangent to throttling portion 74, so that inner surface 68 of duct 62 is free of discontinuity between inlet end 64 and outlet end 66. This means that inner surface 68 of duct 62 has no edge between the different portions.

Throttling portion 74 defines a narrowing of duct 62.

This restriction is the zone where the circulation speed of product is highest.

As visible in FIGS. 2-4, throttling portion 74 preferably has a cylindrical shape of constant section, centered on central axis B-B′.

The length of throttling portion 74 is chosen so as to reduce the micro-bubbling phenomenon in the projected product, while limiting pressure losses.

Preferably, throttling portion 74 has a length L74 measured along central axis B-B, between 0.30 mm and 2.0 mm.

Preferably, throttling portion 74 has a diameter between 0.15 mm and 1.0 mm, preferably between 0.15 mm and 0.7 mm.

The reduction of the transverse section at upstream portion 70, and optionally of inlet portion 76, allows a progressive acceleration of product. At throttling portion 74, the constant transverse section of duct 62 allows product to move at high speed, while enlargement of the transverse section at downstream portion 72 allows deceleration of product.

This contributes to the reduction of the pressure required for spraying, notably by decreasing the viscosity of the product by an effect on the rheofluidifying property of products, in particular paints.

The reduction of the transverse section at throttling portion 74 allows, in addition to rapid movement of product, a local reduction in static pressure, contributing to the overall effect of pressure reduction for spraying, notably by decreasing the viscosity of the product by an effect on the thixotropic property of products, in particular paints.

Preferably, diaphragm 54 has at least one notch 78 or a relief, for example, at its base 56, characteristic of the shape and/or the length of duct 62. For example, the shape and/or the position of notch 78 or the relief depends on the shape and/or the length of duct 62. This allows quick identification of the diaphragm, without requiring measurements.

Preferably, diaphragm 54 is made of a metallic material. For example, diaphragm 54 is made of metallic oxide, in particular zirconium oxide ZrO₂ (also called zirconia).

As visible in FIG. 2, spray nozzle 24 advantageously includes a sealing gasket 80, for example, an O-ring, arranged in duct 40. Gasket 80 here bears on upstream face 56A.

The operation of application device 8 according to the first embodiment will now be described.

A user actuates actuation trigger 12 so as to supply spray head 14 with product.

Coating product, arriving under pressure, enters duct 40 of nozzle 24, then passes through duct 62 of diaphragm 54, successively passing through upstream portion 70, throttling portion 74, and downstream portion 72.

The section reduction at upstream portion 70 allows acceleration of sprayed product, which then circulates rapidly in throttling portion 74, before decelerating in downstream portion 72.

Then, product exits duct 62 and arrives in cavity 46, at free space 60, before passing into channel 48 and exiting nozzle 24 through spray orifice 42.

Coating product then disperses as droplets in the space at nozzle 24 outlet. Despite the relatively low supply pressure of coating product, an excellent dispersion of coating product is obtained, at least similar to that usually observed with conventional supply pressures.

Application device 8 according to the invention thus makes it possible to obtain a finish quality and a transfer rate similar to, or even better than, those usually encountered, with however a reduced supply pressure of coating product.

Furthermore, compactness of diaphragm 54 and its insertion into spraying member 36 makes it possible to minimize dead volumes and thus prevents undesired flows upon releasing trigger 12, in particular when using very fluid products.

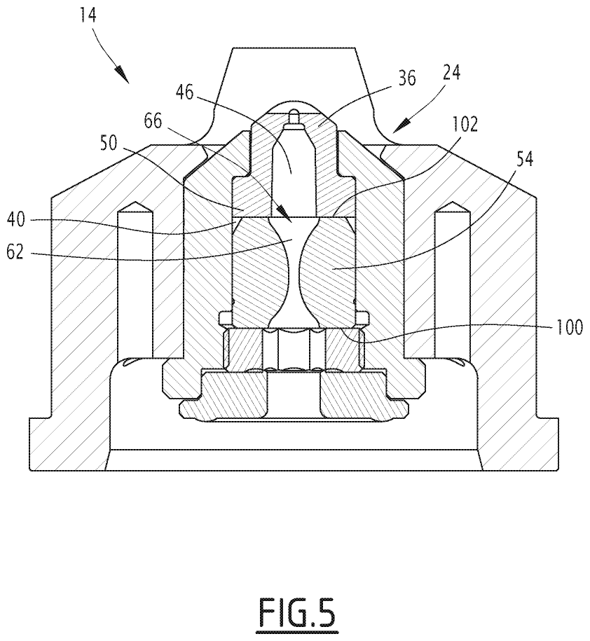

FIG. 5 shows a spray head 14 including a nozzle 24 according to a variant of the first embodiment. In the following, only the differences relative to the first embodiment are mentioned for conciseness. In addition, elements analogous or identical to those of the first embodiment already described retain their numerical references, whereas other elements bear other numerical references.

According to this variant, diaphragm 54 is arranged upstream of spraying member 36, preferably removably. Diaphragm 54 is thus arranged outside cavity 46.

Diaphragm 54 preferably has a shape substantially complementary to the internal shape of through-duct 40 of nozzle 24.

Diaphragm 54 includes an upstream face 100 and an opposite downstream face 102, downstream face 102 advantageously bearing against spraying member 36, and in particular against shoulder 50.

Duct 62 of diaphragm 54 opens at its outlet end 66 into cavity 46.

Diaphragm 54 may have a body not having a shape complementary to that of cavity 46 of spraying member 36. Such a diaphragm 54 may thus easily adapt to different spraying members 36.

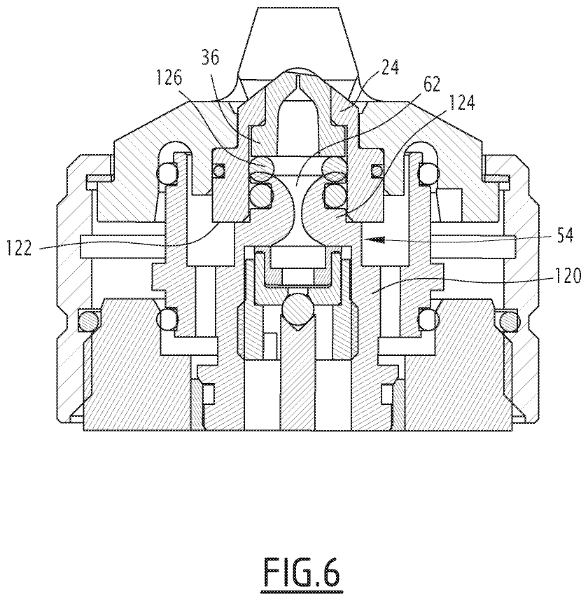

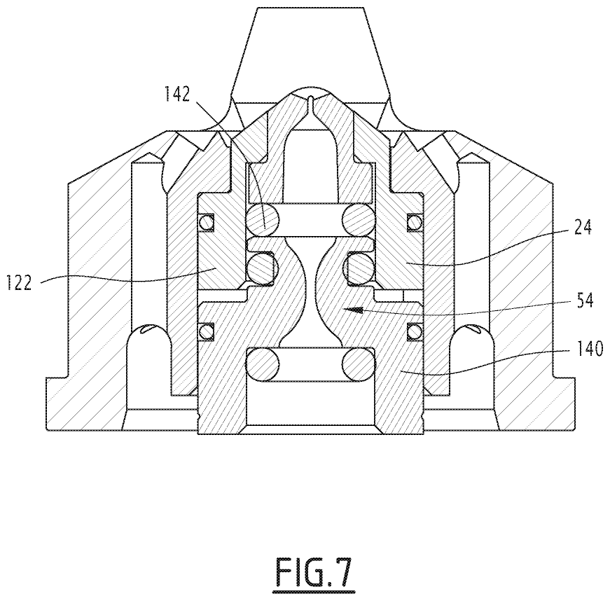

FIGS. 6 and 7 show an application device 8 according to a second embodiment. In the following, only the differences relative to the first embodiment are mentioned for conciseness. In addition, elements analogous or identical to those of the first embodiment retain their numerical references, whereas other elements bear other numerical references.

In this second embodiment, diaphragm 54 is arranged at least partly outside duct 40 of nozzle 24, upstream of spraying member 36, preferably removably.

Device 8 includes a seat holder 120, mounted on body 10 of device 8 and intended to receive in abutment a seat 122 of spray nozzle 24.

According to a first variant of the second embodiment, shown in FIG. 6, seat holder 120 directly defines diaphragm 54.

Thus, seat holder 120 has a downstream end 124, downstream end 124 defining double-funnel duct 62.

Downstream end 124 is here received partly in duct 40 when nozzle 24 is mounted on body 20 of device 8.

Preferably, a sealing gasket 126, here an O-ring, is clamped between downstream end 124 of seat holder 120 and spraying member 36.

According to a second variant of this second embodiment, shown in FIG. 7, diaphragm 54 is formed by an intermediate part 140, itself intended to be mounted on the seat holder (not visible in FIG. 7), so as to be arranged between the seat holder and spray nozzle 24.

Intermediate part 140 thus defines double-funnel duct 62.

Intermediate part 140 is advantageously removable.

Intermediate part 140 forming the diaphragm is received partly in duct 40 and preferably bears against a gasket 142, which is then clamped against spraying member 36.

According to another embodiment (not shown), application device 8 includes several diaphragms 54 as defined above. For example, application device 8 includes a first diaphragm 54 in the form of an insert housed in cavity 46, and a second diaphragm 50 formed by downstream end 124 of seat holder 120.

According to a variant not shown, throttling portion 74 forms a narrowing localized at a plane corresponding to the junction between upstream 70 and downstream 72 portions.

According to a variant not shown, upstream portion 70 and/or downstream portion 72 flares rectilinearly from throttling portion 74 toward respective end 64, 66 of duct 62. The radius of curvature of the portion is then infinite.

The features of the variants and embodiments envisaged above may be combined with each other to generate new embodiments of the invention.

1. A diaphragm for an application device of a coating product, the diaphragm comprising a duct defining a passage for circulation of product, the duct extending along a central axis between an inlet end and an outlet end and having cylindrical symmetry around the central axis, the duct successively comprising:
between the inlet end and the outlet end:
an upstream portion; and
a downstream portion; and
a throttling portion arranged between said upstream and downstream portions and having a narrowed section relative to a section of said upstream and downstream portions, said upstream and downstream portions each having a general shape flaring from the throttling portion toward the respective end of the duct.

2. The diaphragm according to claim 1 wherein said upstream and downstream portions each flare convexly from said throttling portion toward the respective end of the duct.

3. The diaphragm according to claim 1, wherein said throttling portion has a cylindrical shape of constant section.

4. The diaphragm according to claim 1, wherein at least one of said upstream portion and said downstream portion is tangent to said throttling portion.

5. The diaphragm according to claim 1, wherein said upstream portion and said downstream portion each have a respective radius of curvature, the radii of curvature being constant or variable.

6. The diaphragm according to claim 5, wherein the radius of curvature of said upstream portion is different from the radius of curvature of said downstream portion.

7. The diaphragm according to claim 5, wherein the radius of curvature of said downstream portion is strictly greater than the radius of curvature of said upstream portion.

8. The diaphragm according to claim 1, wherein said upstream portion comprises a conical frustum-shaped inlet portion.

9. The diaphragm according to claim 1, wherein said upstream portion and said downstream portion each have a length measured along the central axis such that the length of said upstream portion is between 50% and 100% of the length of said downstream portion.

10. The diaphragm according to claim 9, wherein the length of said upstream portion is between 70% and 90% of the length of said downstream portion.

11. The diaphragm according to claim 1, further comprising a base at which the duct opens at its inlet end.

12. The diaphragm according to claim 11, wherein said base comprises at least one notch or a relief characteristic of the shape and/or the length of the duct.

13. A spray nozzle for an application device of a coating product, the nozzle comprising at least one diaphragm according to claim 1.

14. The spray nozzle according to claim 13, further comprising:
a tubular body oriented along an axial direction and internally defining a through-duct opening onto a spray orifice suitable for spraying product, said at least one diaphragm being housed at least partly in the through-duct of the nozzle; and
a spraying member defining the spray orifice and comprising, from upstream to downstream, a cavity of transverse section decreasing toward downstream, followed by a channel fluidically connecting the cavity to the spray orifice.

15. The nozzle according to claim 14, wherein said at least one diaphragm is housed at least partly in the cavity of said spraying member.

16. The nozzle according to claim 15, wherein said at least one diaphragm is removably housed.

17. The nozzle according to claim 14, wherein said at least one diaphragm is housed upstream of said spraying member.

18. The nozzle according to claim 17, wherein said diaphragm is removable housed.

19. An application device for a coating product, comprising:
a spray nozzle; and
at least one diaphragm according to claim 1.

20. The device according to claim 19, comprising a seat holder for receiving said spray nozzle in abutment, the seat holder defining said at least one diaphragm.
